(19) United States
(12) Patent Application Publication
(10) Pub. No.: US 2019/0077670 A1
(43) Pub. Date: Mar. 14, 2019

(54) Composite Material and Preparation Method Thereof

(71) Applicant: Chung Yuan Christian University, Taoyuan City (TW)

(72) Inventors: Wei-Song Hung, Taoyuan City (TW); Yi-Chen Hsiao, Taoyuan City (TW); Chien-Chieh Hu, Taoyuan City (TW); Hui-An Tsai, Taoyuan City (TW); Kueir-Rarn Lee, Taoyuan City (TW); Juin-Yih Lai, Taoyuan City (TW)

(21) Appl. No.: 15/828,326

(22) Filed: Nov. 30, 2017

(30) Foreign Application Priority Data
Sep. 8, 2017 (TW) 106130766

(51) Int. Cl. C01B 32/194; C01B 32/198

(52) U.S. Cl. CPC C01B 32/194; C01B 2204/20; C01B 2204/04; C01B 32/198

(57) ABSTRACT

A method of preparing a composite material includes the steps of: (a) dispersing graphene material and graphene oxide material in a solution, where the weight ratio of the graphene material to the graphene oxide material is between 0.2-1; and (b) after step (a), stirring the solution at a first temperature.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates generally to a composite material and a method of fabricating the same, and more particularly, to a composite material containing graphene and graphene oxide having good dispersibility in a solution and a method of fabricating the same.

### Description of Related Arts

Graphene is a thin film composed of carbon atoms arranged in a two dimensional honeycomb lattice shape. Due to the strong interatomic force between the carbon atoms of graphene, the graphene film is still robust and sturdy even the thickness of the graphene film is only single-atom-thick. In addition to the advantage of strong mechanical strength that mentioned above, graphene is also characterized by excellent thermal conductivity, electrical conductivity, and light transmittance, so that graphene may be applied in a wide range of applications. For example, graphene material may be applied in communication systems, solar panels, battery materials, touch panel and other electronic devices. On the other hand, graphene may also be a potential material for biomedical engineering, environmental engineering, or other technical fields.

An article by Xu, X. L. et al., entitled “Graphene Oxide Nanofiltration Membranes Stabilized by Cationic Porphyrin for High Salt Rejection,” ACS Appl. Mater. Interfaces, 2016, 8(20), pp 12588-12593, discloses a graphene oxide laminate membrane (GOLM) assembled with cationic porphyrin, also called a cross-linked GOLM, for rejecting salts from solution. The main advantage of the cross-linked GOLM is that the swelling behavior of the graphene oxide sheets within the membrane can be restrained to some extent by incorporating the cationic porphyrin into the graphene oxide laminate membrane. In this way, the salts in the solution can be separated from the solution more effectively.

In order to fabricate the cross-linked GOLM, however, the graphene oxide laminate membrane needs to be modified by the cationic porphyrin. In other words, the structure of the cross-linked GOLM and the process for fabricating the cross-linked GOLM are more complex than those of the conventional GOLMs. Besides, since the main composition of the cross-linked GOLM is graphene oxide, the interlayer spacing of the cross-linked GOLM is greater than the interlayer spacing of a laminate membrane mainly made of graphene. Thus, the cross-linked GOLM disclosed above is only suitable for retaining salts with greater sizes, such as Na2SO4, and is not suitable for retaining salts with smaller sizes, such as NaCl.

To this end, there is a need to provide a composite material with smaller interlayer spacing and a fabrication method thereof. The swelling behavior of the composite membrane should also be restrained to some extent so as to increase the retention ratio for small-sized and large-sized salts.

### SUMMARY OF THE PRESENT INVENTION

According to one embodiment of the present invention, a method of preparing a composite material includes the steps of: (a) dispersing graphene material and graphene oxide material in a solution, where the weight ratio of the graphene material to the graphene oxide material is between 0.2-1; and (b) after step (a), stirring the solution at a first temperature.

According to another embodiment of the present invention, step (a) further comprises the steps of (c) dispersing the graphene oxide material in the solution; and (d) after step (c), dispersing the graphene material in the solution.

According to another embodiment of the present invention, step (c) further comprises applying an ultrasonication process to the solution.

According to another embodiment of the present invention, the first temperature ranges between 1° C. to 25° C.

According to another embodiment of the present invention, the first temperature is 1° C., 10° C. or 25° C.

According to another embodiment of the present invention, the weight ratio of the graphene material to the graphene oxide material is 0.2, 0.4, 0.6, 0.8 or 1.

According to another embodiment of the present invention, the method further comprises filtrating and drying the solution after step (b).

According to another embodiment of the present invention, the solution is selected from the group consisting of H2O, methanol, ethanol, 1-propanol, isopropanol, butanol, isobutanol, ethylene glycol, diethylene glycol, glycerol, propylene glycol, 1-methyl-2-pyrrolidone, γ-butyrolactone, 1,3-dimethyl-2-imidazolidinone, dimethyl formamide, N-methylpyrrolidone and the combination thereof.

According to another embodiment of the present invention, a composite material is provides and comprises graphene sheets stacked with one another; and graphene oxide sheets alternately interposed between the graphene sheets, where a weight ratio of the graphene sheets and the graphene oxide sheets is between 0.2-1.

According to another embodiment of the present invention, each of the graphene sheets and each of the graphene oxide sheets are alternately disposed with one another.

### BRIEF DESCRIPTION OF THE DRAWINGS

For more complete understanding of the embodiments of the present invention and their advantage, reference is now made to the following description, taken in conjunction with accompanying drawings, in which:

FIG. 1 shows the dispersibility of at least one of graphene oxide (GO) and graphene (Gr) in solutions according to Examples and Comparative Examples of the present invention.

FIG. 2 shows Raman spectra of membranes according to Examples and Comparative Examples of the present invention.

FIG. 3 is SEM images showing the structures of membranes according to Examples and Comparative Examples of the present invention.

FIG. 4 is a XRD pattern of each membrane at wet or dry state according to Examples and Comparative Examples of the present invention.

FIG. 5 shows a salt retention ratio of membranes and permeation flux across the membranes according to Examples and Comparative Examples of the present invention.

### DETAILED DESCRIPTION OF THE PREFERRED EMBODIMENT

The invention will be described more fully hereinafter with reference to the accompanying drawings, in which example embodiments of the invention are shown. This invention may, however, be embodied in many different forms and should not be construed as limited to the example embodiments set forth herein. Rather, the disclosed embodiments are provided so that this disclosure will be thorough and complete, and will fully convey the scope of the invention to those skilled in the art.

While the numerical ranges and parameters are used to define a wide range of numerical values of the present invention, the relevant values in the specific embodiments have been shown here as precisely as possible. However, any numerical value inevitably contains, in essence, the standard deviation due to individual test methods. Here, terms “approx.” or “about” generally mean that the actual value is within 10%, 5%, 1%, or 0.5% of a particular value or range. Also, terms “approx.” or “about” could mean that the actual value falls within the acceptable standard error of the average, depending on the consideration of the general knowledge in the technical field to which the invention belongs. In addition to the experimental examples, or unless otherwise expressly stated, it is to be understood that all ranges, numbers, numerals and percentages used herein (for example, to describe the amount of material, duration, temperature, operating conditions, proportions, and so forth) are inherently modified by “approx.” or “about”. Accordingly, unless otherwise stated, the numerical values disclosed in this specification and the accompanying patent claims are numerical value which may be slightly varied depending on the requirements. At the very least, these numerical values should be understood as the number of significant digits and the rounded values. In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with any numerical value and a smaller numerical range thereof in the specification. Besides, the numerical ranges described herein include endpoints unless otherwise specified.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terminology used herein is for the purpose of describing particular embodiments only and is not intended to be limiting. As used herein, the singular terms “a”, “an,” and “the” may be intended to include the plural forms as well, unless the context clearly indicates otherwise.

The term “graphene” (Gr) disclosed herein represents a thin, flat sheet with the thickness of a single layer of carbon atoms. Particularly, graphene consists of SP2 carbon atoms arranged in a hexagonal lattice. The term “graphene”, however, may also represent a thin flake with a layered structure consisting of more than one but less than 10 layers. The total number of the layers may be from 1 to 10, preferably from 1 to 5, and more preferably from 1 to 5 (e.g. 2 to 10 or 2 to 5). Generally, when the surface area of graphene (graphene with a single-layered structure or multi-layered structure) is over 0.005 μm2, preferably between 0.006 to 0.038 μm2, graphene may be in a form of nanosheet. Besides, when the surface area of graphene is less than 0.005 μm2, graphene may be in a form of nanodot. Furthermore, the composition of graphene may include a trace of oxygen atoms, and the ratio of the number of carbon atoms to that of oxygen atoms is preferably greater than 3, and more preferably greater than 10.

The term “graphene oxide” (GO) disclosed herein may be a layered-structure, the main structure of which may be similar to that of graphene but consist of a certain amount of epoxy groups, hydroxyl groups, and carboxyl groups. Preferably, the ration of the number of the carbon atoms to that of the oxygen atoms in graphene oxide is between 1 and 3, and more preferably between 2.1 and 2.9.

According to one embodiment of the present invention, a method for preparing a composite membrane made of graphene and graphene oxide is disclosed and includes the following steps. First, a certain amount of solid graphene oxide is added to a highly polar solvent so as to form a solution with the graphene oxide concentration between 0.01 wt % to 1 wt %. Then, a proper process is applied to let graphene oxide be distributed in the graphene oxide solution. In the next step, graphene is added to the graphene oxide solution where graphene is well-distributed in the solution, and the weight ratio of graphene oxide and graphene is between 1:0.2 to 1:1 (wt %:wt %). Then, the solution containing graphene and graphene oxide is stirred continuously until the ingredients in the solution are well dispersed. Preferably, the temperature (first temperature) during the stirring process is between 1° C. to 50° C. When the temperature is above 50° C., the graphene in the solution may be agglomerated due the temperature of the solution. Preferably, the dispersion of the graphene and graphene oxide in the solution may be better when the temperature of the solution is more close to 1° C. Finally, the solution containing graphene and graphene oxide is filtrated and dried to thereby obtain a composite membrane.

The highly polar solvents mentioned above may be selected from the group consisting of H2O, methanol, ethanol, 1-propanol, isopropanol, butanol, isobutanol, ethylene glycol, diethylene glycol, glycerol, propylene glycol, 1-methyl-2-pyrrolidone, γ-butyrolactone, 1,3-dimethyl-2-imidazolidinone, dimethyl formamide, N-methylpyrrolidone and the combination thereof.

The filtration process for obtaining the composite membrane may be a vacuum filtration or a pressure filtration, but not limited thereto. The drying process may be an oven drying process or other suitable drying processes with suitable temperature during which the solvent of the solution may be evaporated.

For the solution mentioned above, which contains GO and Gr, the good dispersibility of the graphene oxide in the solvent may positively affect the dispersibility of the graphene and thereby increase the dispersibility of the graphene in the solvent. Therefore, compared with the solution mainly containing graphene, the solution containing GO and Gr may have better dispersibility. Furthermore, the composite membrane fabricated from the solution may a quality membrane with a compact and dense structure. Besides, sine the composite membrane made of not only graphene oxide but graphene, the electrical and thermal conductivity of the membrane is also better than that of a conventional membrane made of only graphene oxide.

Besides, the space between any two neighboring sheets within the composite membrane may be adjusted by adjusting the weight ratio of the graphene to the graphene oxide in the solution. For example, when the weight ratio of the graphene oxide to the graphene within the composite material is 1:0.2, the interlayer spacing between two adjacent neighboring sheets within the composite membrane is approximately 10.89 Å. In another case, when the weight ratio of the graphene oxide to the graphene within the composite material is 1:1, the interlayer spacing between two adjacent neighboring sheets within the composite membrane is down to approximately 9.69 Å. In other words, the interlayer spacing within the composite membrane may be narrowed effectively by increasing the proportion of the graphene in the composite membrane.

On the other hand, the swelling behavior of the composite membrane may be restrained by adjusting the weight ratio of the graphene and graphene oxide in the solution. The term “swelling behavior” refers to a phenomenon where the interlayer spacing of a membrane at wet state is greater than that of the membrane at dry state. The reason for the increase in the interlayer spacing of the membrane is that the solvent, such as H2O, passing through the GO membrane may interact with and be adsorbed by the oxygen-containing functional groups on the GO sheets within the GO membrane. For example, for a composite membrane with a GO:Gr ratio of 1:0.2, when the composite membrane is disposed in water, the interlayer spacing of the membrane may increase 2.4 Å from 10.89 Å (dry state) to 13.29 Å (wet state). In contrast, for a composite membrane with a GO:Gr ratio of 1:1, when the composite membrane is disposed in water, the interlayer spacing of the membrane may increase only 2.16 Å from 9.69 Å (dry state) to 11.85 Å (wet state). Therefore, since a membrane with higher proportions of graphene is less likely to adsorb solvent molecules across the membrane, the swelling behavior of the composite membrane may thus be restrained.

According to the embodiment above, the interlayer spacing as well as the swelling behavior of the membranes may be reduced by adjusting the weight ratio of the graphene oxide to the graphene in the solution. Therefore, when the membrane is used in the field of seawater desalination, its retention ratio for both large-sized salts, such as Na2SO4, and small-sized salts, such as NaCl, may be better than that of conventional membranes.

While this invention is described with reference to illustrative embodiments to fully convey the scope of the invention to one of ordinary skill in the art, the description is not intended to be construed in a limiting sense. Various modifications and combinations of the illustrative embodiments, as well as other embodiments of the invention, will be apparent to one of ordinary skill in the art in light of this disclosure.

Preparation of Composite Membrane Made of Graphene and Graphene Oxide

### Example 1

Graphene oxide power (GO, N002-PDE, Angstron Materials, Inc) is added to water to obtain 0.01 wt % to 1 wt % GO solution. Then, the GO solution is treated with ultrasonication to let the graphene oxide fully dispersed in the solution. Subsequently, a certain amount of graphene powder (Gr, N002-PDR, Graphene Powder, Angstron Materials, Inc) is added to the solution containing the well-dispersed graphene oxide, and the weight ratio of the GO to Gr is 1:0.2 in this case. Thus, a solution containing graphene and graphene oxide, also called composite solution, may be obtained. Then, the composite solution is stirred by a homogenizer so as to obtain a well-dispersed solution. The homogenization process is carried out at a first temperature between 1° C. to 50° C., and preferably between 1° C. to 25° C. Finally, the solution containing graphene and graphene oxide is filtrated and dried to thereby obtain a composite membrane.

### Examples 2-5

Example 2-5 are prepared in the same manner as disclosed in Example 1, except that the ratio of GO to Gr in the composite solution of Example 2-5 is 1:0.4, 1:0.6, 1:0.8, and 1:1, respectively.

### Comparative Example 1

Comparative Example 1 is prepared in the same manner as disclosed in Example 1, except that no graphene is added to the solution in Comparative Example 1. That is to say, the solution in Comparative Example 1 is a pure GO solution instead of a composite solution. Thus, a membrane fabricated from the pure GO solution is a pure GO membrane.

### Comparative Example 2

Comparative Example 2 is prepared in the same manner as disclosed in Example 1, except that no graphene oxide is added to the solution in Comparative Example 2. That is to say, the solution in Comparative Example 2 is a pure Gr solution instead of a composite solution. Thus, a membrane fabricated from the pure Gr solution is a pure Gr membrane.

The Examples and Comparative Examples disclosed above are further tested in various processes, and the processes and the corresponding results are disclosed in the following paragraphs.

### Test Example 1—Evaluation of Dispersibility of Solution Containing GO and Gr Using Naked Eye Examination

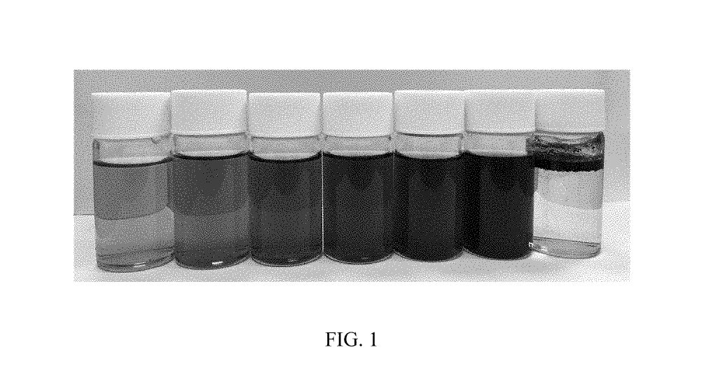

FIG. 1 shows various solutions containing at least one of the graphene oxide (GO) and graphene (Gr), where the leftmost solution and the rightmost solution respectively corresponds to the GO solution of Comparative Example 1 and the Gr solution of Comparative Example 2, and the rest of the solutions from the left the right respectively correspond to the composite material containing solutions of Examples 1-5. As shown in FIG. 1, the Gr solution of Comparative Example 2 (rightmost) has the worst dispersibility where almost all of the Gr is aggregated at top and water is at the bottom. In contrast, the composite solutions of Examples 1-5 (from the second one from the left to the second one from the right) have great dispersibility, which means that GO and Gr are dispersed in the solutions well.

### Test Example 2—Evaluation of Dispersibility of GO and Gr in Solution Using Raman Spectrometer

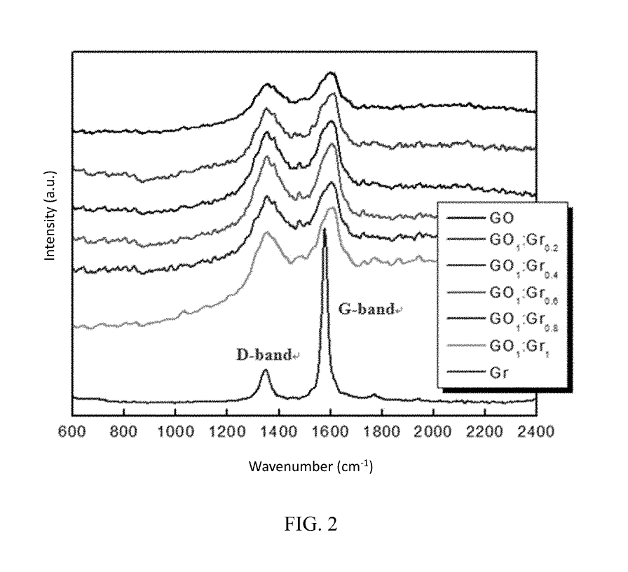

Please refer to FIG. 2. The membranes of Examples 1-5 and Comparative Examples 1 and 2 are evaluated by a Raman spectrometer and the corresponding Raman spectra are recorded in FIG. 2. The curves in FIG. 2 (from top to bottom) correspond to the membranes of Comparative Example 1 (GO), Examples 1-5 (GO1:Gr 0.2-1), and Comparative Example 2 (Gr). As shown in FIG. 2, each curve has a D-band at 1350 cm-1 and a G-band at 1587 cm-1. In generally, when the intensity of the D-band is higher, the dispersibility of the GO and Gr in the solution is greater. In particular, the dispersibility of the components of the membranes in Examples 1-5 is superior to that of the components of the membrane in Comparative Examples 2.

### Test Example 3—Examination of Membrane Structure Using Scanning Electron Microscope

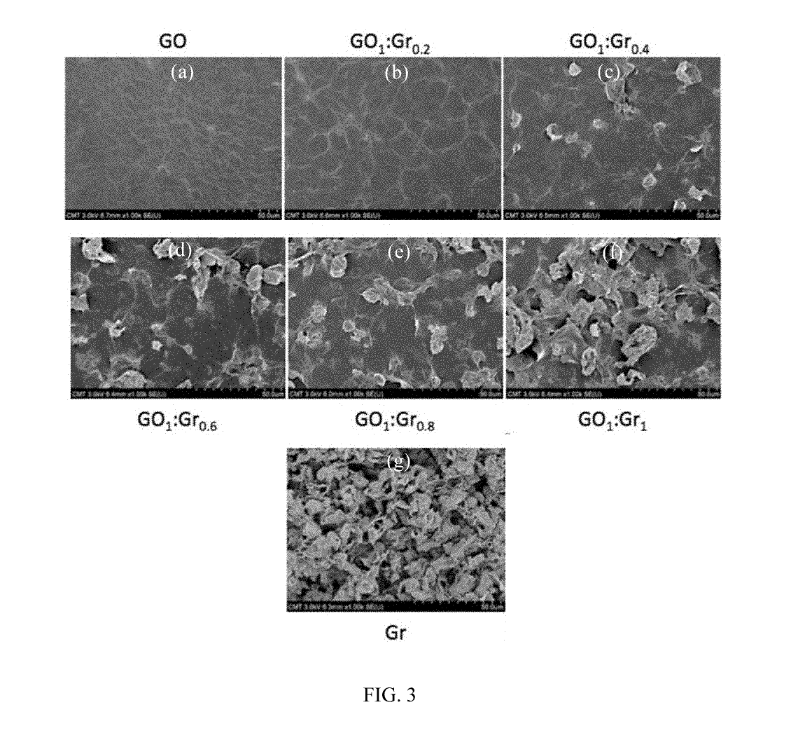

FIG. 3 is SEM images showing the structures of membranes of Examples 1-5 and Comparative Examples 1 and 2 examined by a scanning electron microscope (FE-SEM Model S-4800, Hitachi Co., Japan), where FIG. 3(a) corresponds to the GO membrane of Comparative Example 1, FIG. 3(g) corresponds to the GO membrane of Comparative Example 2, and FIG. 3(b) to FIG. 3(f) respectively corresponds to the composite material containing membranes (GO1:Gr0.2-1) of Examples 1-5. As shown in FIG. 3(g), the Gr membrane is a loose, less-dense, and low-quality membrane, and the membrane has the lowest quality. In contrast, the composite material membranes respectively shown in FIG. 3(b) to and FIG. 3(f) are compact, dense, and high-quality membranes.

### Test Example 4—Evaluation of Interlayer Spacing of Membrane at Dry State and Wet State Using X-Ray Diffraction Technique

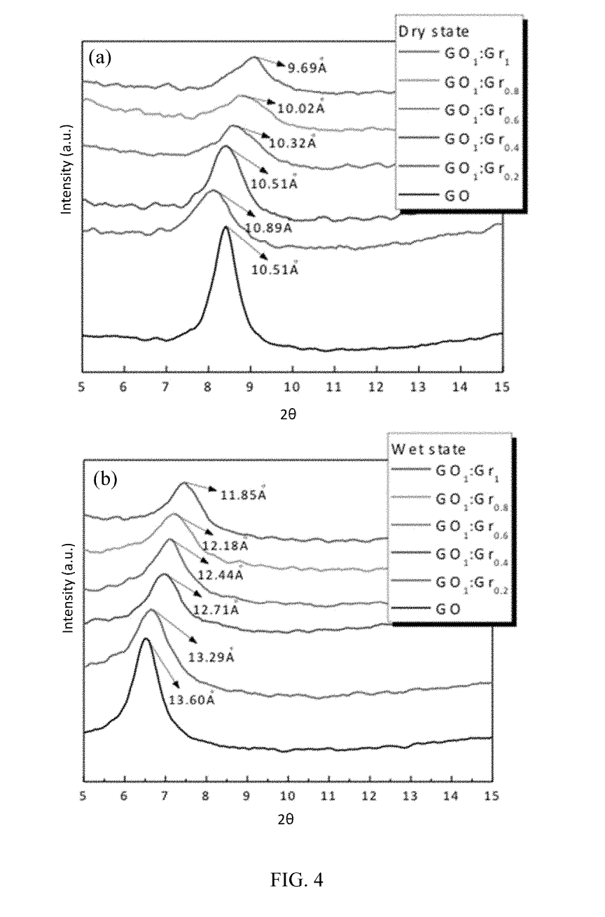

FIG. 4 depicts XRD patterns of membranes at wet and dry state of Examples 1-5 and Comparative Example 1. The equipment used to detect the membranes is Bruker KAPPA APEX II, German. The curves from the bottom to top in FIG. 4(a) and FIG. 4(b) respectively correspond to the membranes of Comparative Example 1 (GO) and Examples 1-5 (GO1:Gr0.2 to GO1:Gr1). The interlayer spacing of each of the membranes can be determined by measuring 2θ value of the maximum intensity in each spectrum. Generally, the greater the 2θ value of the maximum intensity is, the larger the interlayer spacing of the membrane is.

As shown in FIG. 4(a) and FIG. 4(b), when the amount of graphene in the composite membrane increases, the 2θ value of the maximum intensity also increases correspondingly. That is to say, the interlayer spacing of the membrane is narrowed when the amount of graphene in the composite membrane increases. Besides, for any of the membranes of Comparative Example 1 and Examples 1-5, the interlayer spacing of each membrane at the wet state (FIG. 4(b)) is greater than that of each membrane at the dry state (FIG. 4(a)). However, for the composite membrane with higher amount of graphene, the change in the interlayer spacing of the membrane respectively at the wet state and the dry state is lowered. The interlayer spacing and the change in the interlayer spacing for membranes at dry state and wet state are recorded in Table 1.

| | interlayer spacing | interlayer spacing | increase in interlayer |
|---|---|---|---|
| | (Å) in dry state | (Å) in wet state | spacing (Å) |
| Comparative | 10.51 | 13.60 | 3.09 |
| Example 1 | | | |
| Example 1 | 10.89 | 13.29 | 2.4 |
| Example 2 | 10.51 | 12.71 | 2.2 |
| Example 3 | 10.32 | 12.44 | 2.12 |
| Example 4 | 10.02 | 12.18 | 2.16 |
| Example 5 | 9.69 | 11.85 | 2.16 |

According to the result shown in Table 1, the interlayer spacing as well as the swelling behavior of the membranes may be reduced by adjusting the weight ratio of the graphene oxide to the graphene in the composite material containing membrane. Therefore, when the membrane is applied to the field of seawater desalination, it may perform well in the retention ratio for salts with specific sizes or small sizes.

### Test Example 5—Retention Ratios of Various Salts

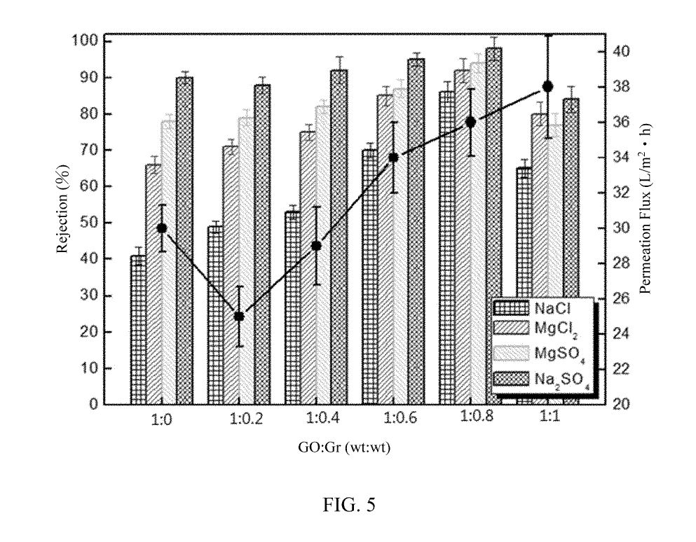

FIG. 5 shows a retention ratio of salts in Examples 1-5 (GO1:Gr0.2-1) and Comparative Example 1 (GO) and corresponding permeation flux across the membranes. The concentration of the feed solution is 1000 ppm, pressure applied to the membranes is 4 kg/cm2. The electrical conductivity of the filtrated solution is measure by an electrical conductivity meter so as to obtain the retention ratio for salts (see the bar chart in FIG. 5). The filtrated solution is also weighed to obtain water flux for each membrane (see the line chart in FIG. 5).

According to the result shown in FIG. 5, for each membrane, the salt retention ratio generally obeys the following order: Na2SO4>MgSO4>MgCl2>NaCl. The reason is that the salt retention ratio is directly influenced by the sizes and the amount of the negative charges of the salts. In general, the larger the size of a salt is, the less easily the salt passes across a membrane. Besides, since the GO within the membrane is often negatively charged, salts with more negative charges are more likely to be repelled by the negatively charged GO within the membrane and thereby less likely to pass through the membrane.

The retention ratio of various salts, such as Na2SO4, MgSO4, MgCl2, and NaCl generally increases as the weight ratio of GO to Gr in the membrane increases from 1:0 to 1:0.8. The reason for the increase in the retention ratio of salts is that not only the interlayer spacing of the membrane may be reduced but the swelling behavior of the membrane may be restrained as the amount of the graphene increases. According to one embodiment of the present invention, the membrane may achieve its best retention ratio when the weight ratio of GO to Gr is 1:0.8 within the membrane.

For large-sized salts, such as Na2SO4, although the electrostatic repulsion force between the salts and the membrane may reduce as the amount of graphene in the membrane increases, the retention ratio of salts may be kept over 80% because the interlayer spacing and swelling behavior of the membrane is reduced or restrained by increasing the proportion of the graphene. In particular, when the ratio of GO to Gr is respectively 1:0.4, 1:0.6, and 1:0.8, the retention ratio of Na2SO4 may further increase to over 90%. Furthermore, when the weight ratio of GO to Gr is 1:0.8, the retention ratio of Na2SO4 reaches almost 100%.

Besides, since the number of the oxygen-containing functional groups in the composite membrane is inversely proportional to the amount of the graphene in the composite membrane, the membrane may become more hydrophobic as the amount of the graphene in the composite membrane increases. Thus, water flux across the composite membrane may increase as the proportion of the graphene in the membrane increases. As shown in FIG. 5, when the ratio of GO to Gr in each membrane is 1:0.6, 1:0.8, and 1:1, the water flux across these membranes is higher than the water flux across a pure GO membrane.

In sum, the embodiments of the present invention disclose composite membranes made of graphene oxide (GO) and graphene (Gr) and methods for fabricating the same. The interlayer spacing as well as the swelling behavior of the membranes may be reduced by adjusting the weight ratio of the graphene oxide to the graphene in the composite solution. Therefore, when the membrane is applied to the field of seawater desalination, the retention ratio of both large-sized salts, such as Na2SO4, and small-sized salts, such as NaCl, may perform well.

What is claimed is:

1. A method for fabricating a composite material, comprising the steps of:
(a) dispersing a graphene material and a graphene oxide material in a solution, wherein a weight ratio of the graphene material to the graphene oxide material in the solution is between 0.2-1, and
(b) after step (a), stirring the solution at a first temperature.

2. The method of claim 1, wherein step (a) further comprises the steps of:
(c) dispersing the graphene oxide material in the solution; and
(d) after step (c), dispersing the graphene material in the solution.

3. The method of claim 2, wherein step (c) further comprises applying an ultrasonication process to the solution.

4. The method of claim 1, wherein the first temperature ranges between 1° C. to 25° C.

5. The method of claim 4, wherein the first temperature is 1° C., 10° C. or 25° C.

6. The method of claim 1, wherein the weight ratio of the graphene material to the graphene oxide material is 0.2, 0.4, 0.6, 0.8 or 1.

7. The method of claim 1, after step (b), further comprising filtrating and drying the solution.

8. The method of claim 1, wherein the solution is selected from the group consisting of H2O, methanol, ethanol, 1-propanol, isopropanol, butanol, isobutanol, ethylene glycol, diethylene glycol, glycerol, propylene glycol, 1-methyl-2-pyrrolidone, γ-butyrolactone, 1,3-dimethyl-2-imidazolidinone, dimethyl form amide, N-methylpyrrolidone and the combination thereof.

9. A composite material, comprising:
a plurality of graphene sheets stacked with one another; and
a plurality of graphene oxide sheets alternately interposed between the graphene sheets, wherein a weight ratio of the graphene sheets and the graphene oxide sheets is between 0.2-1.

10. The composite material of claim 9, wherein each of the graphene sheets and each of the graphene oxide sheets are alternately disposed with one another.
